(19) United States
(12) Patent Application Publication
(10) Pub. No.: US 2014/0341593 A1
(43) Pub. Date: Nov. 20, 2014

(54) Method And Apparatus For Optical Transmission In A Communication Network

(71) Applicants: ALCATEL-LUCENT USA INC., Murray Hill, NJ (US); ALCATEL-LUCENT, Boulogne-Billancourt (FR)

(72) Inventors: Doutje T. van Veen, New Providence, NJ (US); Robert Farah, Marlboro, NJ (US); Peter Vetter, Summit, NJ (US); Wolfgang Poehlmann, Hemmingen (DE)

(73) Assignees: ALCATEL-LUCENT USA INC., Murray Hill, NJ (US); ALCATEL-LUCENT, Boulogne-Billancourt (FR)

(21) Appl. No.: 14/279,642

(22) Filed: May 16, 2014

Related U.S. Application Data
(60) Provisional application No. 61/823,979, filed on May 16, 2013.
(60) Provisional application No. 61/824,320, filed on May 16, 2013.

(51) Int. Cl. H04B 10/50; H04B 10/564

(52) U.S. Cl. CPC H04B 10/503; H04B 10/564
USPC 398/201

(57) ABSTRACT

A manner of mitigating the self heating effect of a laser or other light source such as a laser in a network node of a communication network. A self-heating mitigation module is provided, the self-heating mitigation module includes one or both of a self-heating adjustment module to accelerate self heating at the beginning of a transmission and a sub-threshold lasing module that applies a sub-threshold current between transmissions. The self-heating adjustment module and the sub-threshold lasing module are preferable both used together and driven by a common signal, for example the burst_enable signal that facilitates transmission from the light source.

### CROSS-REFERENCE TO RELATED APPLICATIONS

The present disclosure is related to and claims priority from U.S. Provisional Patent Application Ser. No. 61/823,979 entitled Mitigation of Burstmode Laser Wavelength Drift due to Selfheating and filed on 16 May 2013, and U.S. Provisional Patent Application Ser. No. 61/824,320 entitled Mitigation of Wavelength Drift due to Self-Heating of Directly-Modulated Burstmode Laser and filed on 16 May 2013, the entire contents of which applications are incorporated by reference herein.

### TECHNICAL FIELD

The present invention relates generally to the field of communication networks, and, more particularly, to a method and apparatus for sending optical transmission in an optical communication network, for example a passive optical access network.

### BACKGROUND

The following abbreviations are herewith expanded, at least some of which are referred to within the following description of the state-of-the-art and the present invention.
CO Central Office
DFB Distributed Feedback (laser)
FET Field Effect Transistor
OLT Optical Line Terminal
ONT Optical Network Terminal
ONU Optical Network Unit
PON Passive Optical Network

Optical networks use lasers or similar light sources to transmit information using modulated light beams The lasers may be tunable to different wavelengths by altering their temperature, and heaters or heater/coolers are frequently used for this purpose. An operating laser will often generate heat itself, however, and this may affect the wavelength at which the laser is transmitting.

In any individual network node the transmission may be more or less continuous, and the self-heating effect may simply be designed for in selecting the operating wavelength or corrected using a feedback and adjustment circuit, or both. In some nodes, however, for example ONUs (optical network units) in a PON (passive optical network), transmissions may occur in bursts with relatively longer periods of inactivity in between, allowing the non-transmitting laser to cool more than with continuous operation.

In either case, there may be detrimental or undesirable effects of the self-heating phenomenon, specifically transmission at an improper wavelength for a period of time. Feedback and correction circuits are frequently to slow to adequately address this problem, so other solutions are needed.

### SUMMARY

The present invention is directed to a manner of mitigating the self heating of a laser or other light source in a network node of a communication network. Herein, self-heating mitigation refers to reducing or alleviating the detrimental or undesirable effects of self heating, for example by accelerating the self heating so that it occurs largely or totally at the beginning of a transmission, preferably in a portion of the transmission known as the preamble.

In one aspect, the present invention is a network node including laser light source and circuitry for driving the laser light source, wherein the circuitry comprises a self-heating mitigation module. The network node may further include a processor for controlling operation of components of the network node, and a memory device for storing executable program instructions.

In a preferred embodiment, the network node of the present invention includes executable program instructions stored on the memory device that when executed cause the network node to form a transmission preamble initially dominated by 1 bits. In this embodiment, the formed preamble gradually assumes a bit pattern comprising alternating 1 bits and 0 bits.

In the same or another preferred embodiment, the self-heating mitigation module includes a sub-threshold lasing module configured to selectively apply a sub-threshold current to the laser light source. The sub-threshold lasing module is controlled, for example, by a burst_enable signal generated in the network node or by some other signal.

In the same or another preferred embodiment, the self-heating mitigation module includes a self-heating adjustment module configure to accelerate the self-heating of the laser light source. The self-heating adjustment module may include, for example, RC circuit configured for producing an overshoot of laser bias current at the beginning of a transmission. The self-heating adjustment module may also be controlled by a burst_enable signal generated in the network node.

In another aspect, the present invention is a method operating a network node comprising a laser light source, the method comprising accelerating self heating of the laser light source at the beginning of a transmission. This may be accomplished for example by forming a transmission preamble initially dominated by 1 bits.

In a preferred embodiment, accelerating the self heating of the laser light source includes applying an overshoot of the laser current at the beginning of a transmission. This application may be triggered by a burst_enable signal.

In the same or another preferred embodiment, the method of the present invention includes selectively applying a sub-threshold lasing current to the laser light source. The sub-threshold lasing current is preferably only applied when the laser light source is in a non-transmitting state, and may be deactivated if the laser light source is not operational for extended periods. The sub-threshold lasing current application may be triggered by a burst_enable signal.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is schematic diagram illustrating selected components of a PON in which embodiments of the present invention may be advantageously implemented;

FIG. 2 is a block diagram illustrating selected components of an ONU node according to an embodiment of the present invention;

FIG. 3 is a block diagram illustrating selected components of an optical transmitter according to an embodiment of the present invention;

FIG. 4 is a schematic diagram illustrating selected components of an optical transmitter according to an embodiment of the present invention;

FIG. 5 is a schematic diagram illustrating selected components of an optical transmitter according to an embodiment of the present invention;

FIG. 6 is a schematic diagram illustrating selected components of an optical transmitter according to an embodiment of the present invention;

FIGS. 7a and 7b are timing diagrams illustrating a portion of a transmission according to an embodiment of the present invention; and

FIG. 8 is a flow diagram illustrating a method of operating a network node according to an embodiment of the present invention.

### DETAILED DESCRIPTION

The present invention is directed to an apparatus and method for sending optical transmissions in a communication network. The method is expected to be of particular advantage when implemented in an ONU (optical network unit) of a PON (passive optical network), and will be herein described in those terms even though some or all aspects of the invention may be implemented in other environments as well. A PON for implementing the present invention will now be described in more detail.

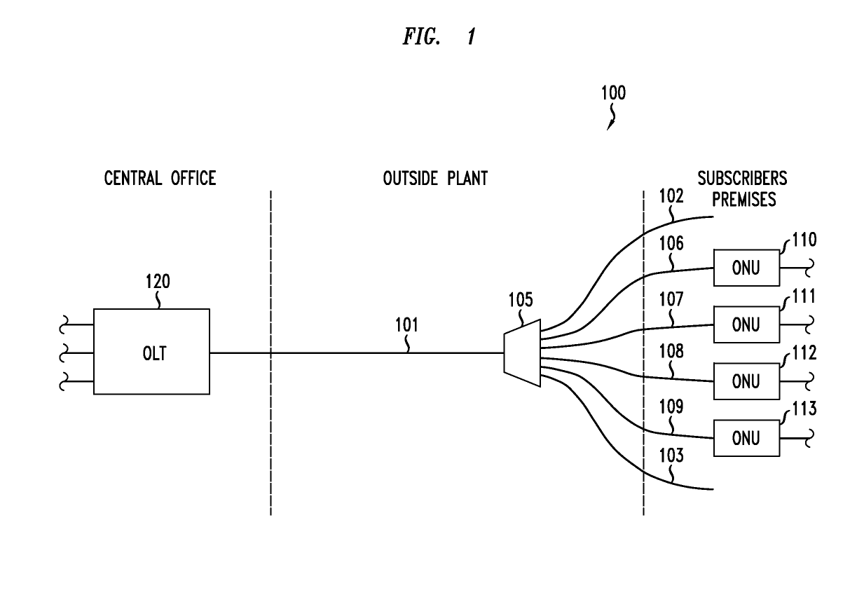

FIG. 1 is schematic diagram illustrating selected components of a PON 100 in which embodiments of the present invention may be advantageously implemented. Note that PON 100 may, and in many implementations will, include additional components, and the configuration shown in FIG. 1 is intended to be exemplary rather than limiting. Four ONUs, 110 through 113, are shown, although in a typical PON there may be many more or, in some cases, fewer. In this illustration, each of the ONUs are presumed to be located at and serving a different subscriber, perhaps at their respective residences or other premises. The ONU at each location is connected or connectable to a device of the subscriber, or to a network of such devices (not shown).

PON 100 also includes an OLT (optical line terminal) 120, which communicates directly or indirectly with various sources of content and network-accessible services (not shown) that are or may be made available to the subscribers associated with PON 100. As should be apparent, OLT 120 handles the communications between these other entities and the ONUs. OLT 120 may also be involved in regulating the PON and individual ONUs. As mentioned above, the OLT 120 is typically located at a service provider location referred to as a central office. The central office may house multiple OLTs (not separately shown), each managing their own respective PON.

OLT 120 is in at least optical communication with each of the ONUs in the PON 100. In the embodiment of FIG. 1, OLT is connected with the ONUs 110 through 113 via a fiber optic cable 101 and fiber optic cables 106 through 109. In this PON, a single splitter 105 is used to distribute a downstream transmission so that each ONU receives the same downstream signal. In other optical networks, the splitter may also separate the signal into different wavelengths, if used, associated with each or various of the respective ONUs.

Upstream transmissions from the ONUs are often made according to a schedule set by the OLT, and use a wavelength or wavelengths different from that used for downstream transmission to avoid interference. In some PONs the ONUs will each be assigned a unique time slot and can all use the same upstream transmission wavelength; in others, any number of ONUs may be assigned the same time slot but use different wavelengths to avoid interference. In a preferred embodiment, the ONU has a tunable light source so that its upstream transmission wavelength can be changed.

The splitter in a PON is typically a passive element requiring no power. The splitter may also serve as a combiner for combining upstream traffic from the ONUs to the OLT. The splitter may be located, for example, in a street-side cabinet near the subscribers it serves (FIG. 1 is not necessarily to scale). This cabinet or similar structure may be referred to as the outside plant. Note, however, that no particular network configuration is a requirement of the present invention unless explicitly stated or apparent from the context.

Also illustrated in FIG. 1 are fiber optic cables 102 and 103, which are also connected to optical splitter 105 and which may in the future be connected to ONUs (not shown) yet to be installed. Although ONUs may vary according to age, manufacturer, capabilities, and so forth, in a preferred each ONU on the PON will be configured for mitigating the undesirable effects of self heating that are prevalent especially in nodes that tend to use bursty as opposed to continuous upstream transmission. Note that this mitigation is of advantage in networks where tunable lasers are employed in the ONUs, but may be implemented in other environments as well. Embodiments of mitigation configuration according to the present invention will now be described in greater detail.

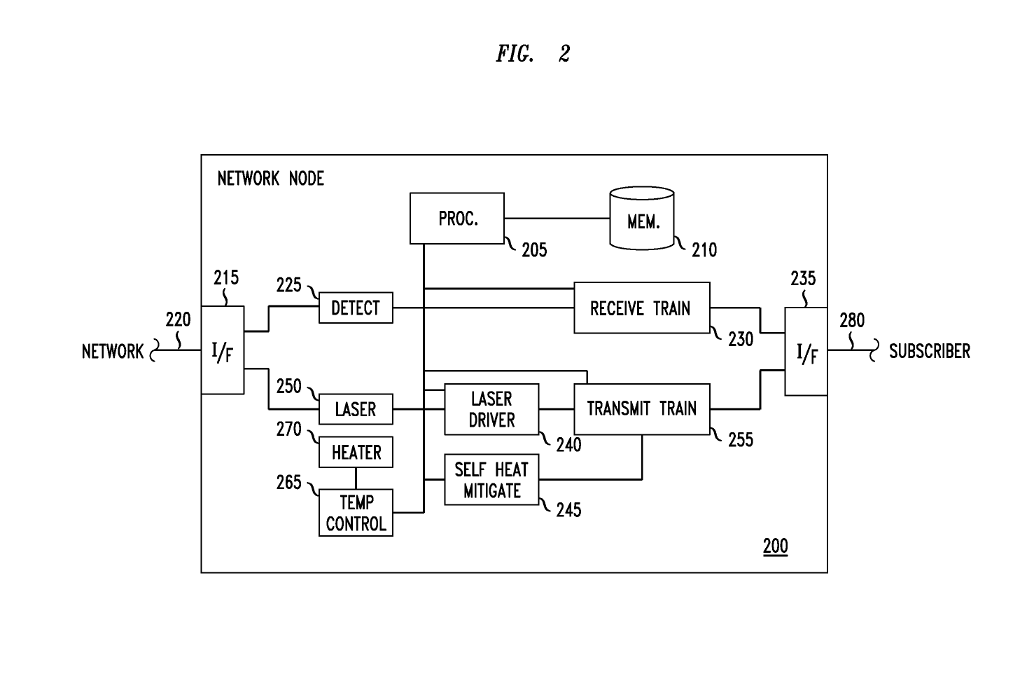

FIG. 2 is a block diagram illustrating selected components of an ONU node 200 according to an embodiment of the present invention. In this embodiment, OLT 200 includes a processor 205 and a memory device 210. Processor 205 may be implemented in hardware or program instructions executing on a hardware device, or both. Memory device 210 in this embodiment is a physical storage device that may in some cases operate according to stored program instructions. In any case, memory 210 is non-transitory in the sense of not being merely a propagating signal unless explicitly recited to the contrary in a particular embodiment. Memory 210 is used for storing, among other things, data and executable program instructions for execution by processor 205.

In the embodiment of FIG. 2, ONU 200 also includes a PON interface 215, through which ONU 200 communicates with, for example an OLT (see, for example, FIG. 1). PON interface 215 includes a splitter/combiner or similar device (not separately shown) for allowing downstream optical signals to light detector 225 and upstream signals from light source 250 to transit along access fiber 220. Downstream transmissions received at light detector 225 are processed by a receive train 230.

Correspondingly, upstream transmissions are processed by transmit train 255 prior and then provided to light source 250 for transmission on access fiber 220. Receive train 230 and transmit train 255 are also in communication with processor 205 and with subscriber interface 235, which may include for example a port for connecting a coaxial cable 280 leading to a router in a subscriber's residence.

In this embodiment, light source 250 is a laser such as a directly-modulated DFB (distributed feedback) laser. The laser's output wavelength is tunable according to changes in temperature. In operation, therefore, ONU 220 may send upstream transmissions according to an assigned wavelength. A heating element 270 is provided for this purpose. Heating element 270 is operated by a temperature control unit 265 based on instructions from, in this embodiment, processor 205. Note that in other embodiments, a cooling element may also be present.

In the embodiment of FIG. 2, shown separately are laser driver 240 for driving transmit operations of laser 250 according to information provided by transmit train 255, and a self heating mitigation module 245 according to this embodiment of the present invention. The function of these devices will be described in more detail below. Note, however, that the description of self-heating mitigation elements herein does not preclude the use of other mitigation elements as well. Here it is noted that the term “self-heating mitigation” is used to describe techniques to mitigate the detrimental effects of self heating by the laser or other light source, rather than (necessarily) to reduce the self-heating phenomenon itself.

Note also that FIG. 2 illustrates selected components of an embodiment of the present invention and some variations are possible without departing from the claims of the invention as there recited. In some of these embodiments, illustrated components may be integrated with each other or divided into subcomponents. There will often be additional components in the ONU and in some cases less. The illustrated components may also perform other functions in addition to those described above. The components may be implemented as physical devices and may execute instructions stored as software in a non-transitory medium, for example memory 210. In addition, the some or all of the components described may reside outside of an ONU, although such an arrangement is not presently preferred.

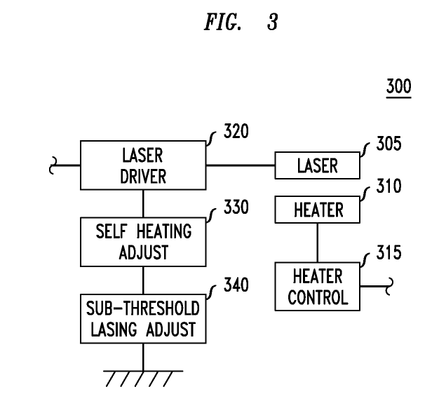

FIG. 3 is a block diagram illustrating selected components of an optical transmitter 300 according to an embodiment of the present invention. Optical transmitter 300 may, for example, be a component of an optical network node (see, for example, FIG. 2) such as an ONU in a PON. Although the term “optical transmitter” is used here for convenience, it is intended as a general term to describe illustrated or recited components and there is no intention to imply that a particular component must or must not be a part of an optical transmitter. As mentioned above, the present invention may be of greatest advantage where a light source is routinely operated in burst mode, exacerbating the problems that may be caused by self-heating.

In the embodiment of FIG. 3, optical transmitter 300 includes a tunable laser diode 305 and a heating element 310, which is used to tune the laser diode to an appropriate wavelength for transmission. Heating element 310 is controlled by heater control circuitry 315. A thermister or similar temperature-sensing device (not shown) may be present to provide indications of the temperature of the laser diode.

In this embodiment, a laser driver 320 is provided and includes circuitry (not separately shown in FIG. 3) for operating the laser diode 305. Laser driver 320 and heater control 315 may operate under a local processor (not shown), for example the processor resident in an ONU (see, for example, FIG. 2).

In accordance with this embodiment of the present invention, optical transmitter 300 also includes a self-heating adjustment module 330 that is configured to accelerate the self-heating of the laser diode 305. Here, the self-heating adjustment module 330 is for this purpose connected to the laser driver 320. This accelerated self heating is accomplished, in this embodiment, by overshooting the laser current, usually at the beginning of a burst transmission. The self-heating acceleration may be triggered, for example, by the burst_enable signal (not shown in FIG. 3) that in most cases is already being generated in a network node.

In the embodiment of FIG. 3, optical transmitter 300 also includes sub-threshold lasing adjust module 340. Lasing adjust module 340 is in this embodiment connected to self-heating adjustment module 330 and provides for a heating current below the laser threshold flows to be applied to the laser diode 305 when a transmission is not taking place. The amount of self-heating attributable to the burst transmission is therefore reduced as some heating will already have taken place due to the sub-threshold current. The sub-threshold lasing adjust module 340 is preferably also triggered by the burst_enable signal. In some implementations, sub-threshold lasing adjust module 340 may be selectively deactivated, for example during long periods of inactivity to save power.

In a preferred embodiment, the network node applies both the self-heating adjustment module 300 and the sub-threshold lasing adjust module 340 to mitigate the detrimental effects of laser self heating, especially that associated with burst-mode operation. In this case the combination of adjustment module 300 and the sub-threshold lasing adjust module 340 may be considered analogous to the self heating mitigation module depicted in FIG. 2.

Note also that FIG. 3 illustrates selected components of an embodiment of the present invention and some variations are possible without departing from the claims of the invention as there recited. In some of these embodiments, illustrated components may be integrated with each other or divided into subcomponents. There will often be additional components in the ONU and in some cases less. The illustrated components may also perform other functions in addition to those described above. The components may be implemented as physical devices or and may execute instructions stored as software in a non-transitory medium, for example memory 210 (see FIG. 2). In addition, the some or all of the components described may reside outside of an ONU, although such an arrangement is not presently preferred.

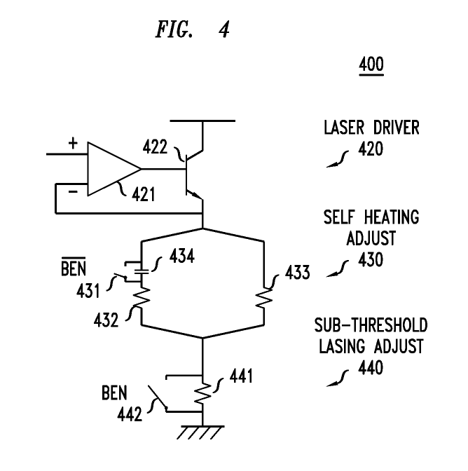

FIG. 4 is a schematic diagram illustrating selected components 400 of an optical transmitter according to an embodiment of the present invention. In this embodiment, these components include a laser driver 420, a self heating adjustment module 430, and a sub-threshold lasing adjustment module 440. These components have been discussed above and while their composition and even presence may vary by embodiment, their functions are generally uniform unless noted to the contrary.

In the embodiment of FIG. 4, two components of the laser driver 420 are illustrated; an operational amplifier 421 and a transistor 422 (shown here as an NPN bi-polar junction transistor).

In this embodiment, the self heating adjust module 430 includes an RC circuit having capacitor 434 and two resistors 432 and 433 configured as shown. Switching element 431, triggered by B̅Ē N̅ (inverse of burst_enable signal) switches capacitor 434 in and out of what is effectively a laser bias circuit to reduce resistance in the bias current path such that there is an overshoot at the beginning of a transmission burst until the capacitor 434 charges at τ=R₄₃₂C₄₃₄. When the burst begins, R₄₃₂//R₄₃₃ is associated with the initial current to accelerate self heating; R₄₃₃ is associated with the final current.

In the embodiment of FIG. 4, the sub-threshold lasing adjust module 440 includes a resister 441 and a switching element 442, which switches the laser current between regular later current during the bursting (transmitting) state and a sub-threshold laser current during the off (non-transmitting) state. Switching element 442 is triggered by the BEN (burst_enable) signal, although it is noted here that there is no requirement that the all switching elements are controlled by the same signal.

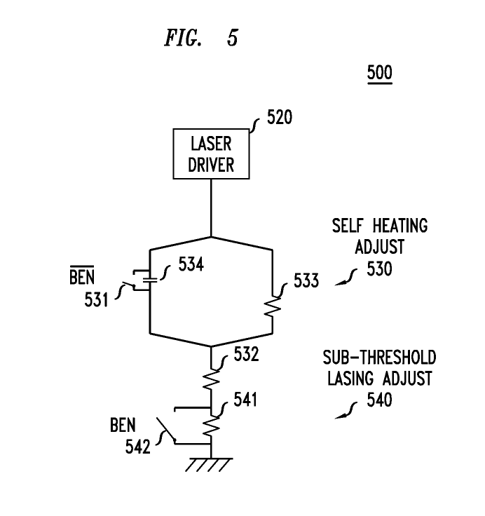

FIG. 5 is a schematic diagram illustrating selected components 500 of an optical transmitter according to an embodiment of the present invention. As with the components depicted in FIG. 4, in the embodiment of FIG. 5 the selected components include a laser driver 520, a self heating adjustment module 530, and a sub-threshold lasing adjustment module 540. For simplicity, the individual elements of the laser driver 520 are not separately shown.

In the embodiment of FIG. 5, the self heating adjust module 530 includes an RC circuit having capacitor 534 and two resistors 532 and 533 configured as shown. Switching element 531, triggered by B̅Ē N̅ (inverse of burst_enable signal) switches capacitor 534 in and out of what is effectively a laser bias circuit to reduce resistance in the bias current path such that there is an overshoot at the beginning of a transmission burst until the capacitor 534 charges at τ=(R_{533//}R₅₃₂) C₅₃₄.

In the embodiment of FIG. 5, the sub-threshold lasing adjust module 540 includes a resister 541 and a switching element 542, which switches the laser current between regular later current during the bursting (transmitting) state and a sub-threshold laser current during the off (non-transmitting) state. Analogous to the embodiment of FIG. 4, switching element 542 is triggered by the BEN (burst_enable) signal.

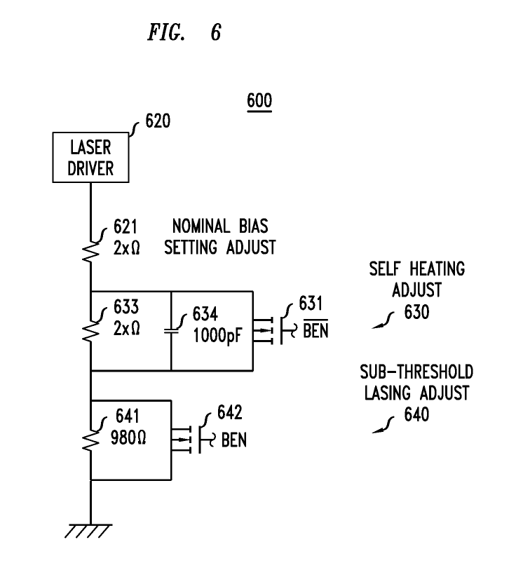

FIG. 6 is a schematic diagram illustrating selected components 600 of an optical transmitter according to an embodiment of the present invention. As with the components depicted in FIGS. 4 and 5, in the embodiment of FIG. 6 the selected components include a laser driver 620, a self heating adjustment module 630, and a sub-threshold lasing adjustment module 640. In FIG. 6, a nominal bias setting adjustment resister 621 is also employed. For simplicity, the individual elements of the laser driver 620 are not separately shown.

FIG. 6 includes resistor and capacitor values (in ohms (or k-ohms) and picofarads), from an exemplary simulation. The actual values may of course vary according to the parameters and needs of a particular implementation.

In the embodiment of FIG. 6, the self heating adjust module 630 includes an RC circuit having capacitor 634 and a resistor 633 configured as shown. Switching element 631, in this case illustrated as an FET (field effect transistor) is again triggered by B̅Ē N̅ (inverse of burst_enable signal) switches capacitor 634 in and out of what is effectively a laser bias circuit to reduce resistance in the bias current path such that there is an overshoot at the beginning of a transmission burst until the capacitor 634 charges.

In the embodiment of FIG. 6, the sub-threshold lasing adjust module 640 includes a resister 641 and a switching element 642, which switches the laser current between regular later current during the bursting (transmitting) state and a sub-threshold laser current during the off (non-transmitting) state. Analogous to the embodiment of FIGS. 4 and 5, switching element 642 is triggered by the BEN (burst_enable) signal.

FIGS. 4 through 6 illustrate selected components of respective embodiments of the present invention and some variations or equivalent circuits are possible without departing from the claims of the invention as there recited. In some of these embodiments, illustrated components may be integrated with each other or divided into subcomponents.

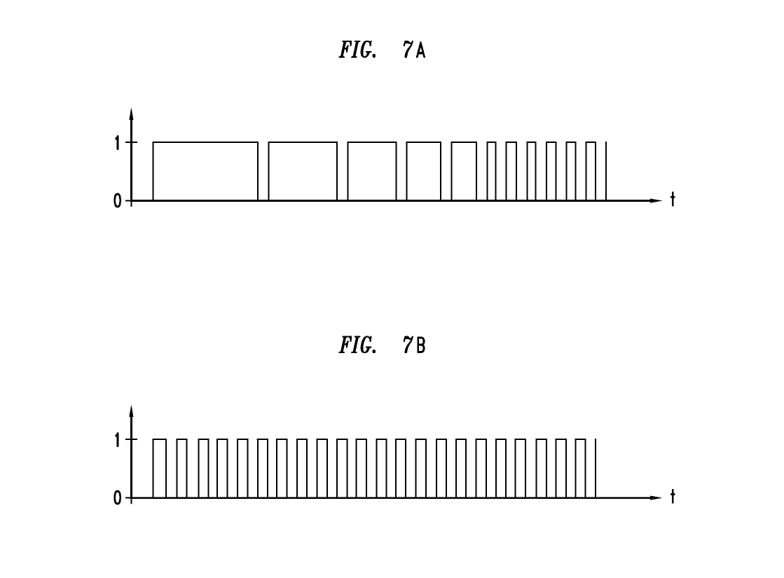

FIGS. 7a and 7b are timing diagrams illustrating a portion of a transmission according to an embodiment of the present invention. In a preferred embodiment, for additional self heating mitigation, the network node 200 (see FIG. 2) is configured to adjust the transmission preamble bit pattern of a transmission such that it begins with all is (or at least predominately is). As the 1 bit is associated with a higher laser current, laser self heating will be accelerated using this technique. After an initial period, the preamble may be returned to the usual balanced “1010 . . . ” or another sequence to facilitate recognition and synchronization in the receiver. The initial period for applying preamble bit adjustment is preferably variable at the direction of a network operator, for example at the direction of an OLT in a PON.

FIG. 7b illustrates a conventional pattern of alternating 1s and 0s throughout the preamble transmission. FIG. 7a illustrates a pattern of predominately is at the beginning of the preamble transmission according to this embodiment of the present invention. Note that no exact pattern is required with this embodiment, and some variation may be employed to suit specific environments. Note also that this preamble adjustment may be used with either of the self heating adjustment or the sub-lasing threshold adjustment techniques, or with both.

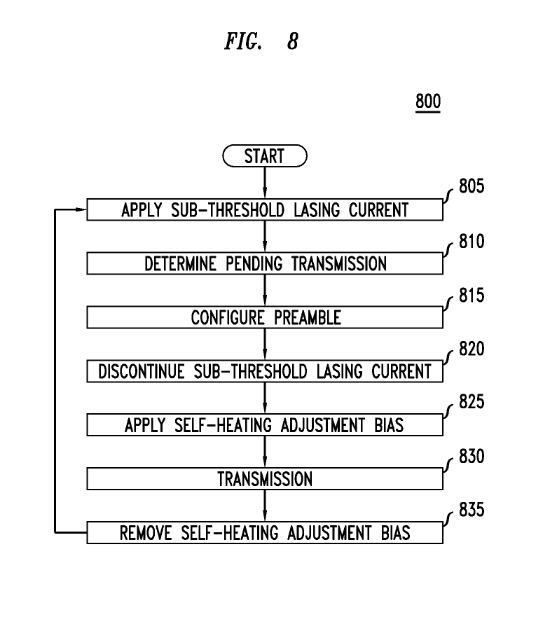

FIG. 8 is a flow diagram illustrating a method 800 of operating a network node according to an embodiment of the present invention. Again, the network node may be an ONU operating in a PON. At START it is presumed that the necessary components are available and operational according to at least this embodiment. The process of this embodiment then begins with applying (step 805) a sub-threshold lasing current to a laser that will be used for transmission. This is naturally an advantage when the network node will be sending burst mode transmissions, but the type of transmission is not a requirement of the invention unless specifically recited.

Application of the sub-threshold lasing current may be but is not necessarily controlled by a burst_enable signal. The sub-threshold lasing current may be applied whenever the laser is not transmitting, but it may also be withheld when no transmissions have been made for some time. In that case it may be desirable to provide for a wakeup signal to resume application of the sub-threshold lasing current during non-transmission periods (not separately shown). Such a wake up signal may happen periodically or according to another schedule or based, for example, on perceived activity in the subscriber network on the PON.

In this embodiment, a determination is then made that a transmission is pending (step 810). In many PONs, this occurs in an ONU according to a schedule received from the OLT of the PON. This determination may also include determining whether there is currently any information for transmission.

In the embodiment of FIG. 8, when a determination is made that a transmission is pending, the transmission preamble is configured (step 815) to begin with all or predominately 1s, as described above in reference to FIGS. 7a and 7b. Note that this configuration may involve either the initial configuration or the modification of an existing transmission.

In this embodiment, the sub-threshold lasing adjustment current is then discontinued (step 820), and a self-heating adjustment bias is put in place (step 825). As mentioned above, these steps may be but are not necessarily controlled by the same signal such as a burst_enable signal. The transmission may then commence (step 830).

As should be apparent, the self heating mitigation steps described here are intended to both accelerate the self heating that naturally occurs during a burst mode (or any other) transmission and to reduce the actual increase in temperature experienced. Embodiments of the present invention help to mitigate undesirable effects of self heating in this fashion. Note that at some point, the temperature of the laser will reach a relatively stable value for the bulk of the transmission.

In the embodiment of FIG. 8, when the transmission is complete, the self-heating adjustment bias is put removed (step 835) and the sub-threshold lasing adjustment current is then re-applied at step 805. The process continues with each successive transmission unless halted or modified.

Note that the sequence of message flow illustrated in FIG. 8 represents an exemplary embodiment; some variation is possible within the spirit of the invention. For example, additional techniques may be added to those shown in FIG. 8, and in some implementations one or more of the illustrated operations may be omitted. In addition, the operations of the method may be transmitted and received in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A network node, comprising
a laser light source; and
circuitry for driving the laser light source, wherein the circuitry comprises a self-heating mitigation module.

2. The network node of claim 1, further comprising:
a processor for controlling operation of components of the network node; and
a memory device for storing executable program instructions.

3. The network node of claim 2, further comprising executable program instructions stored on the memory device that when executed cause the network node to form a transmission preamble initially dominated by 1 bits.

4. The network node of claim 3, wherein the formed preamble gradually assumes a bit pattern comprising alternating 1 bits and 0 bits.

5. The network node of claim 1, wherein the self-heating mitigation module comprises a sub-threshold lasing module configured to selectively apply a sub-threshold a sub-threshold current to the laser light source.

6. The network node of claim 5, wherein the sub-threshold lasing module is controlled by a burst_enable signal generated in the network node.

7. The network node of claim 1, wherein the self-heating mitigation module comprises a self-heating adjustment module configure to accelerate the self-heating of the laser light source.

8. The network node of claim 7, wherein the self-heating adjustment module comprises an RC circuit configured for producing an overshoot of laser bias current at the beginning of a transmission.

9. The network node of claim 6, wherein the self-heating adjustment module is controlled by a burst_enable signal generated in the network node.

10. A method operating a network node comprising a laser light source, the method comprising accelerating self heating of the laser light source at the beginning of a transmission.

11. The method of claim 10, wherein accelerating self heating of the laser light source comprises forming a transmission preamble initially dominated by 1 bits.

12. The method of claim 10, wherein accelerating self heating of the laser light source comprises applying an overshoot of the laser current at the beginning of a transmission.

13. The method of claim 12, wherein the applying an overshoot of the laser current is controlled by a burst_enable signal.

14. The method of claim 10, further comprises selectively applying a sub-threshold lasing current to the laser light source.

15. The method of claim 14, wherein the sub-threshold lasing current is only applied when the laser light source is in a non-transmitting state.

16. The method of claim 14, wherein the sub-threshold lasing current application is controlled by a burst_enable signal.

17. The method of claim 14, further comprising deactivating application of the sub-threshold lasing current when the laser light source is not operated for extended periods.
